(19) United States
(12) Patent Application Publication
(10) Pub. No.: US 2002/0157290 A1
(43) Pub. Date: Oct. 31, 2002

(54) Apparatus and method for displaying advertising

(76) Inventors: Odysseas Raptis, Athens (GR); Nikolaos Arapis, Veroia (GR)

Correspondence Address: Marion P. Metelski, Amster, Rothstein & Ebenstein, 90 Park Ave., New York, NY, 10016, US

(21) Appl. No.: 09/842,985

(22) Filed: Apr. 26, 2001

(51) Int. Cl. G09F 19/00; G09F 7/00

(52) U.S. Cl. 40/436; 40/601

(57) ABSTRACT

An apparatus and method for displaying advertising. A movable medium displays an image thereon and moves within an exterior casing. A base structure enables vertical movement of the exterior casing to facilitate access to the apparatus. An interior frame is located within the exterior casing and includes adjustable bearings to secure, position, and guide the movement of the movable medium. A top portion of the exterior casing can be opened to provide access to the interior of the exterior casing. An object is disposed in front of the movable medium. The movement of the image in relation with the object creates the effect that the object is moving in relation to the image.

### BACKGROUND OF THE INVENTION

It is known to use backlit panel structures for outdoor advertising. Such prior art structures are difficult and costly to maintain. Access to the interiors of such prior art backlit panel structures may typically be provided through doors at the back of the structure, or alternatively by detaching and raising a front part of the structure by some maximum angle, e.g., 30°. Consequently, accessing the interior mechanisms and light sources of these prior art structures requires that the advertising media that are included within these structures first be removed. Removing the advertising medium, for example, may take a crew of workers several hours to accomplish depending on the manner in which the advertising medium is suspended within the structure and the means of accessing the advertising medium.

Further complicating the situation is that such prior art backlit structures are normally positioned high enough above the ground so that the advertising content displayed by the structure may be viewed from some distance. The height of the structure, in conjunction with the manner in which the advertising medium is suspended within the structure, may require an entire crew of workers, one of whom must use a ladder, to remove the advertising medium from the interior of the structure. For example, one method for suspending the advertising medium within the structure involves a series of hooks provided on a rotating chain. The height of the structure thus would necessitate that one worker controls the rotation of the movable medium so that at least one other worker, using the ladder, can detach the advertising medium from the hooks of the rotating chain. Being on a ladder, even in the best of circumstances, is inherently dangerous for a worker because of the appreciable risk that he could fall off the ladder and suffer a serious injury, or perhaps even die. This risk can increase significantly as circumstances deviate from the ideal, e.g., inclement weather, wind, distracting noise or activity in the area of the structure, illness of the worker, etc.

Thus, maintenance of such a structure can be complicated, costly, and dangerous when the frame is high above the ground. Accordingly, there is a need in the art for an advertising apparatus that easier, less costly, and safer to maintain.

### SUMMARY

The present invention is directed to an improved advertising apparatus and method that satisfies the need for an advertising apparatus that is easier, less costly, and safer to maintain.

According to an embodiment of the present invention, an apparatus for displaying advertising comprises: a movable medium which moves within an exterior casing and which displays an image thereon; an object disposed in front of the movable medium, whereby the movement of the image in relation with the object creates the effect that the object is moving in relation to the image; and a base structure that enables vertical movement of the exterior casing to facilitate access to the apparatus.

According to another embodiment of the present invention, a method for displaying advertising comprises the steps of: moving a medium which displays an image thereon within an exterior casing; disposing an object in front of the medium, whereby the movement of the image in relation with the object creates the effect that the object is moving in relation to the image; and enabling vertical movement of the exterior casing to facilitate access to an apparatus embodying the method.

The above, and other features, aspects, and advantages of the present invention will become apparent from the following description read in conjunction with the accompanying drawings, in which like reference numerals designate the same elements.

### BRIEF DESCRIPTION OF THE DRAWINGS

In the drawings:

FIG. 1 shows a front perspective view of an apparatus according to the present invention;

FIG. 2 shows a side plan view of the apparatus of FIG. 1;

FIG. 3 shows a side plan view of an alternate embodiment of the present invention;

FIG. 4 shows an inventive aspect of the embodiment of the present invention shown in FIG. 3;

FIG. 5A-5C show different views of an interior frame used in the embodiments of the present invention;

FIG. 6 shows the interior of the apparatus of FIG. 1;

FIG. 7 shows an inventive aspect of the embodiments of the present invention;

FIG. 8 shows a rear plan view of a suspension frame used with the embodiments of the present invention;

FIG. 9 shows a top plan view of the suspension frame shown in FIG. 8;

FIG. 10 shows inventive aspects of the embodiments of the present invention shown in FIGS. 1 and 2;

FIG. 11 shows further inventive aspects of the embodiments of the present invention shown in FIGS. 1 and 2;

FIGS. 12 and 12A show inventive aspects of the embodiment of the present invention shown in FIG. 11; and

FIG. 13 shows an exemplary embodiment according to the present invention.

### DESCRIPTION OF THE PREFERRED EMBODIMENTS

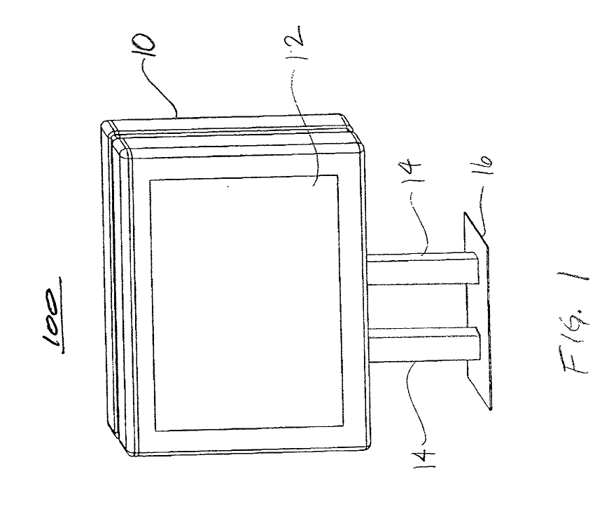

FIG. 1 shows a front view of a billboard apparatus for displaying advertising, generally designated 100, according to an embodiment of the present invention. A preferred embodiment of billboard apparatus 100 has an exterior casing 10 that has a generally rectangular shape, but which may also have a curved shape. The exterior casing 10 may consist of either structural or morphological elements, or some combination of both types of elements. In a presently preferred embodiment, each of the length, width, and height of the exterior casing 10 can range from, for example, approximately 0.05 m all the way up to approximately 15 m. Exterior casing 10 can be manufactured using any suitable material, including metals, polymers, or other heavy-duty materials. Suitable metal materials include, but are not limited to, aluminum, iron, titanium, and duraluminum. Suitable polymers include, but are not limited to, various plastics. Suitable heavy-duty materials include, but are not limited to, wood, cement or brick.

The exterior casing 10 has at least one opening through which a spectator or a passerby can view a background image, as will be described further herein. In a presently preferred embodiment, a transparent member 12, including but not limited to glass, PLEXIGLAS, a membrane, or a perforated metal sheet, is disposed within the opening of the exterior casing 10 to cover the opening.

The presently preferred embodiment of billboard 100 further includes two vertical footing beams 14 that are connected to a metal plate 16 to form a base structure. As will be appreciated by those skilled in the art, alternative embodiments of the present invention may utilize only a single footing beam 14, or perhaps more than two footing beams 14, in the base structure. Additionally, alternative embodiments of the present invention may utilize more than one base structure.

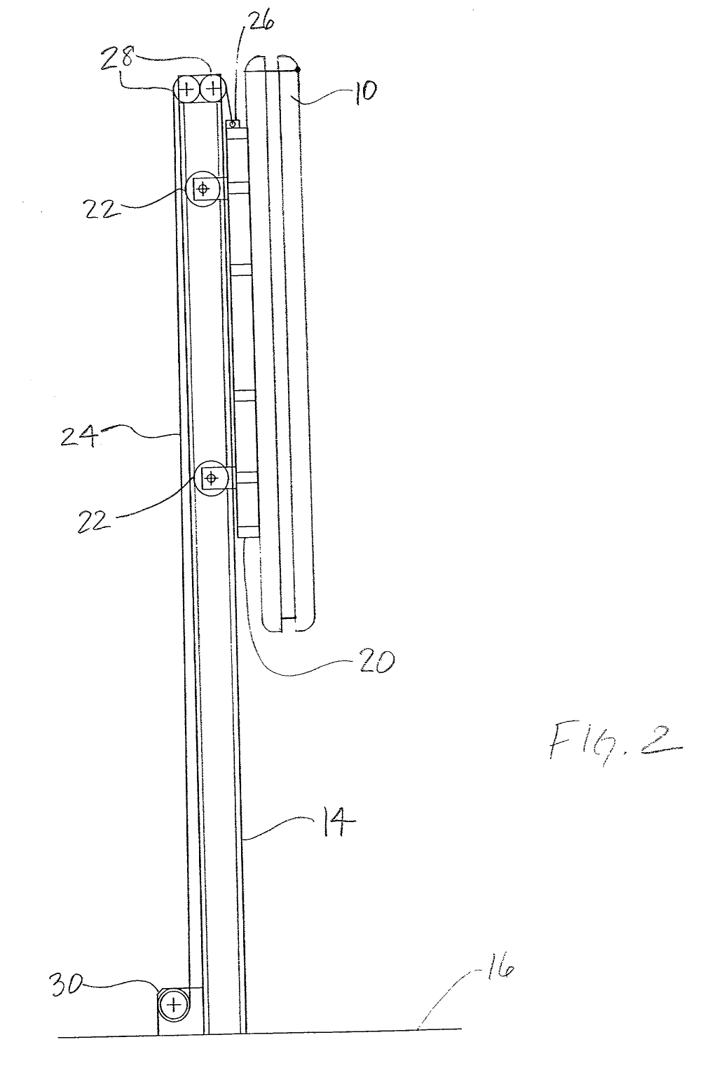

According to an embodiment of the invention shown in FIG. 2, the exterior casing 10 is secured to a suspension frame 20 that slides vertically along I-shaped footing beams 14 using the rollers 22 to enable the exterior casing 10 to be lowered to ground level. A cable 24 is provided from flange 26 of suspension frame 20, over pulleys 28, and is collected by winch 30. When positioned as shown, winch 30 provides a particular length of cable 24 which determines the height of suspension frame 20 and, consequently, exterior casing 10 shown in FIG. 2. When actuated in a counterclockwise manner, winch 30 increases the length of cable 24, and suspension frame 20 and exterior casing 10 are lowered accordingly. Conversely, when actuated in a clockwise manner, winch 30 decreases the length of the cable 24, and suspension frame 20 and exterior casing 10 are raised accordingly. It will be apparent to those skilled in the art that winch 30 need not be located on plate 16, but may be placed in other locations, e.g., atop footing beams 14. Additionally, it will be apparent to those skilled in the art that, for larger dimensions of the exterior casing 10, more than one cable 24, winch 30, and suspension frame 20 may be necessary to effect vertical movement of exterior casing 10.

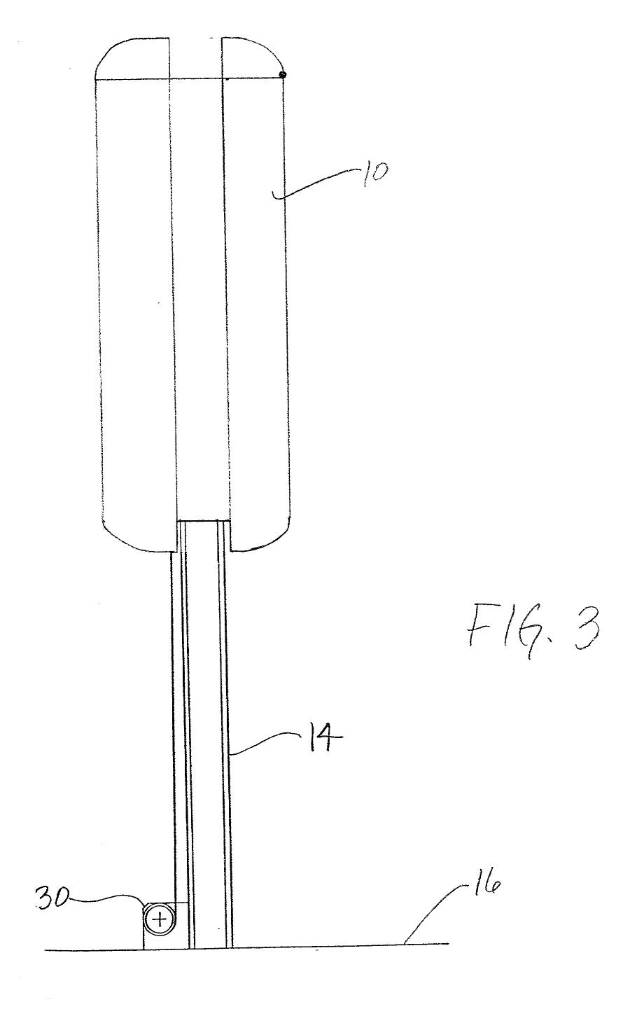

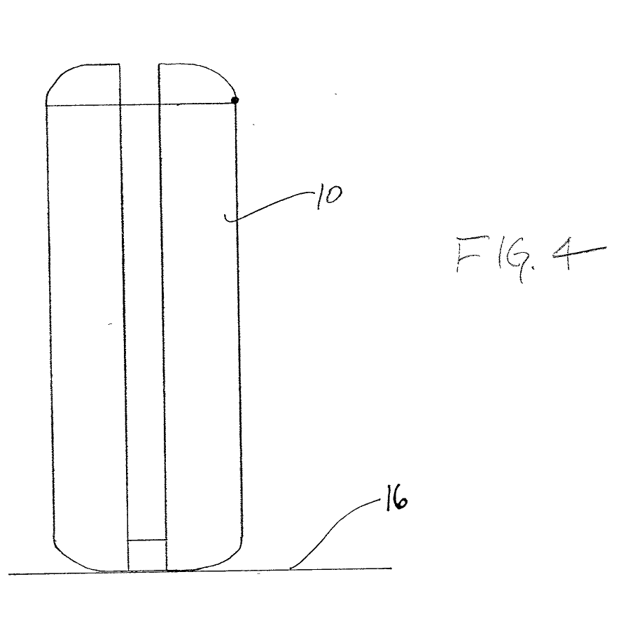

In a further embodiment shown in FIG. 3, footing beams 14, suspension frame(s) 20, and cable(s) 24 are enclosed by exterior frame 10. When exterior casing 10 is lowered to ground level, as shown in FIG. 4, it envelops footing beams 14, suspension frame(s) 20, cable(s) 24, and winch(es) 30. This embodiment is particularly useful for displaying advertising on two sides of the apparatus.

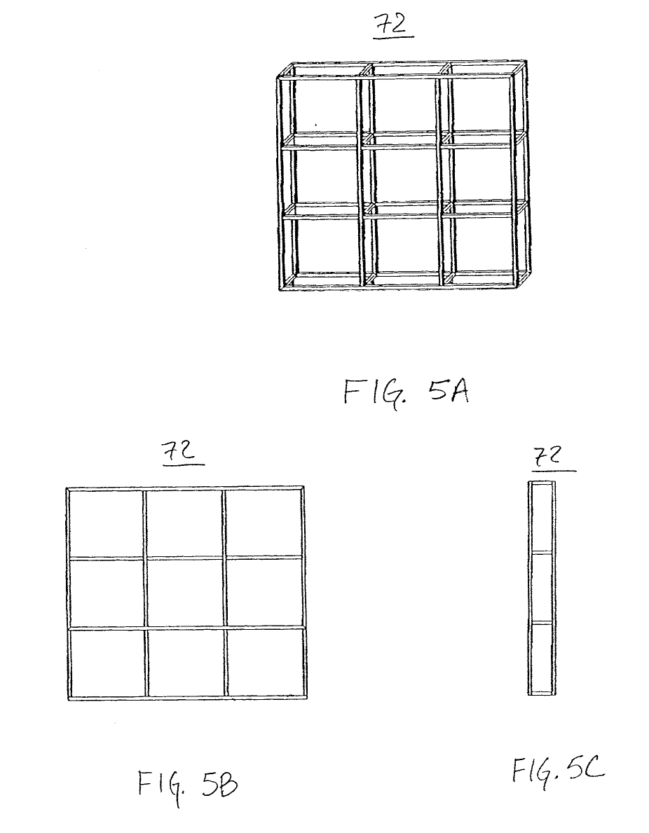

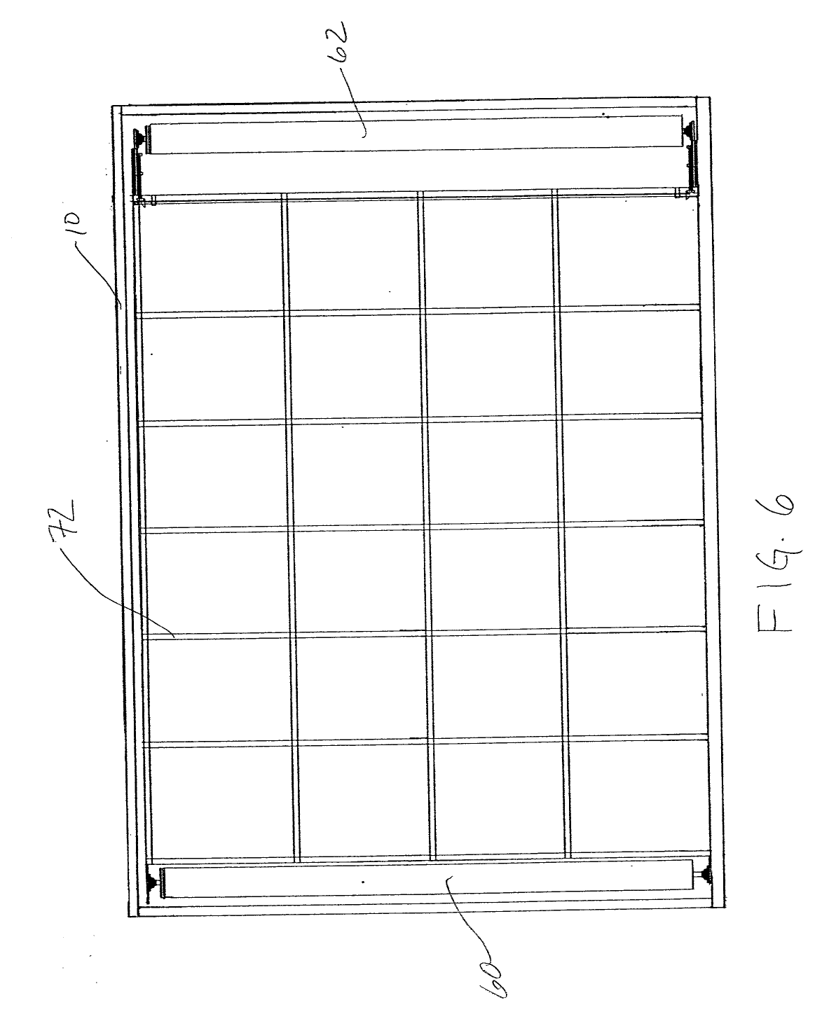

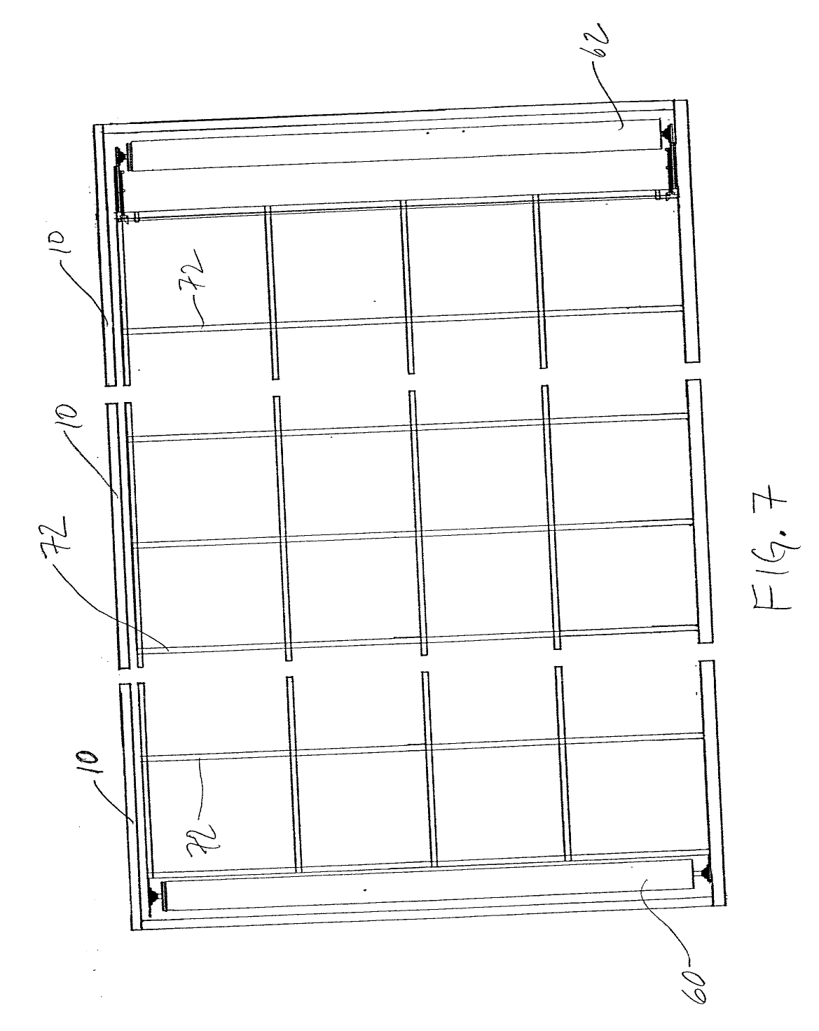

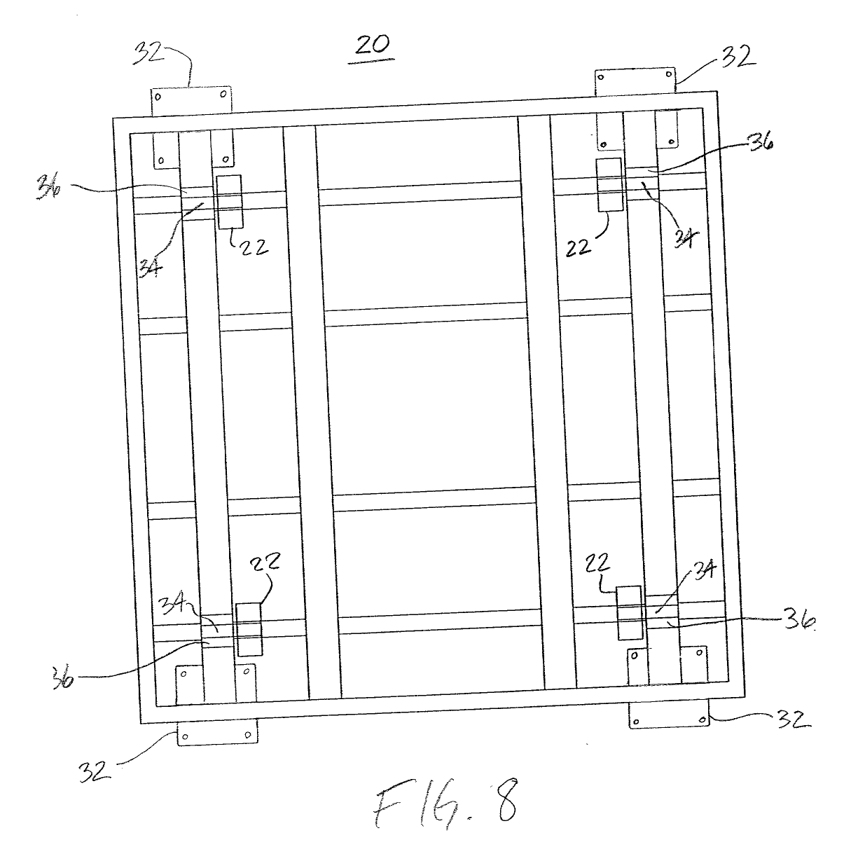

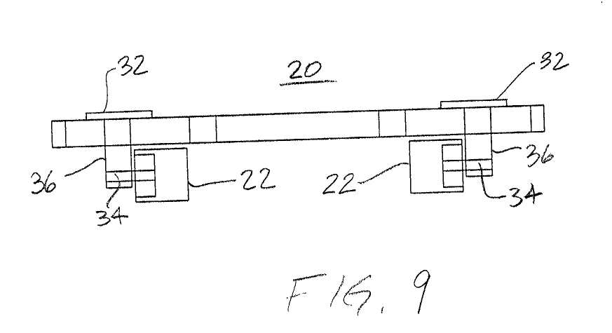

In this embodiment, suspension frame(s) 20 (shown in FIG. 2) is secured to an appropriate portion of an interior structure of exterior frame 10 using any suitable technique known to those skilled in the art, e.g., screws, bolts, etc. An exemplary interior frame 72 shown in FIGS. 5A-5C is located within exterior casing 10 as shown in FIG. 6. Interior frame 72 can be formed using any suitable material, e.g., square lumen pipe. To facilitate transport of billboard apparatus 100, exterior casing 10 and interior frame 72 are preferably constructed by attaching component pieces together in a conventional manner. The component pieces preferably are dimensionally equal and are cut in the vertical direction. In a presently preferred embodiment shown in FIG. 7, exterior casing 10 and interior frame 72 are constructed from three component pieces, but those skilled in the art will readily appreciate that billboard apparatus 100 can be constructed using some other number of pieces.

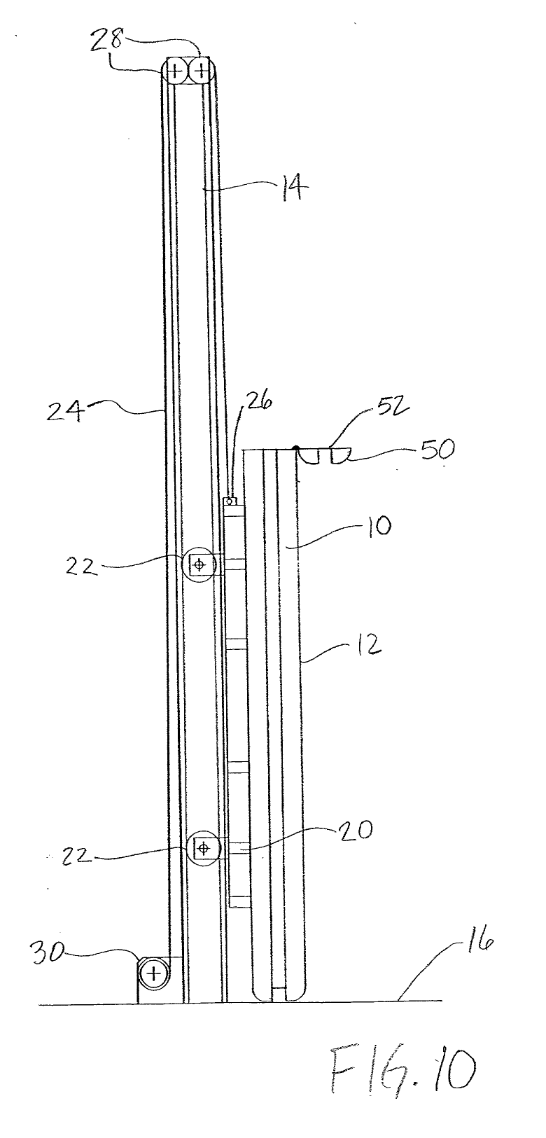

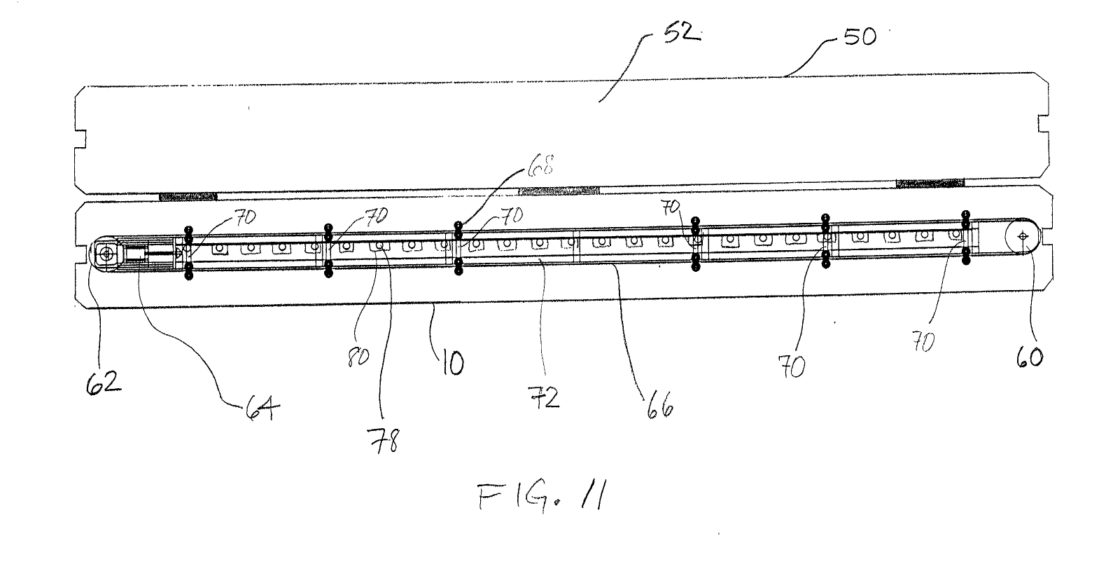

Referring to FIGS. 8 and 9, in a presently preferred embodiment of the present invention, plates 32 are provided at the corners of suspension frame 20 to secure it to exterior casing 10 or interior frame 72 using screws. It will be readily apparent to those skilled in the art that suspension frame 20 can be secured to exterior casing 10 or interior frame 72 using other conventional techniques that are well known to those skilled in the art. Suspension frame 20 is also provided with rollers 22 to enable suspension frame 20 to be lowered or raised along footing beams 14. As shown most clearly in FIG. 9, the axles of rollers 22 are disposed in protruding members 36 of suspension frame 20.

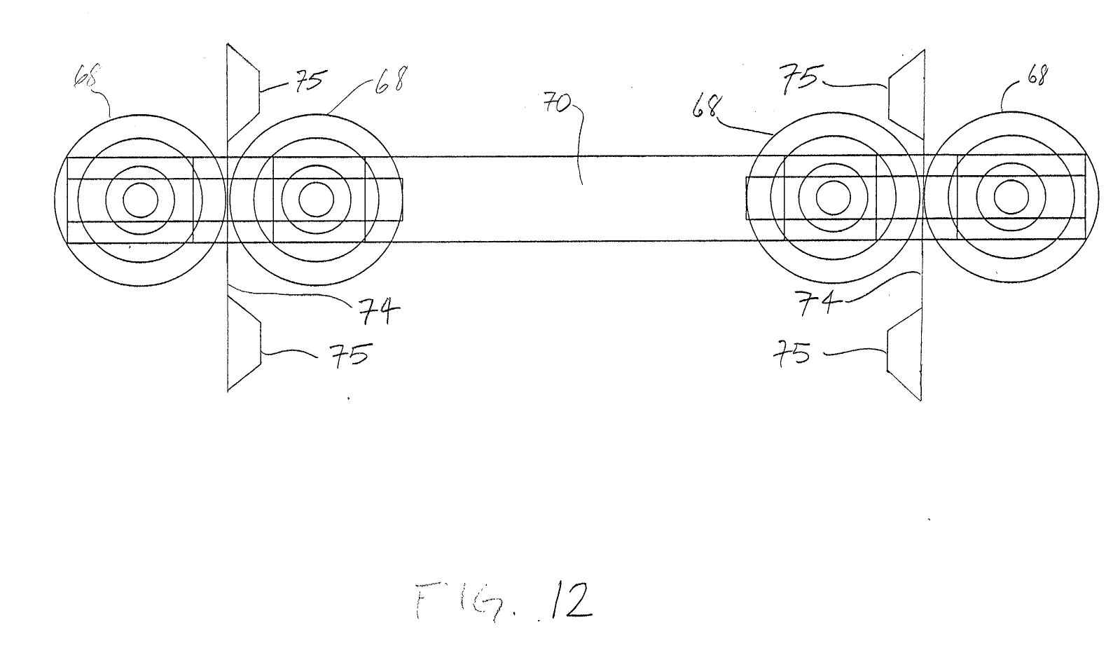

According to a further embodiment of the present invention, access to the interior of the billboard apparatus 100 is provided from the top of the exterior casing 10. Referring to FIG. 10, the billboard apparatus 100 is shown resting on metal plate 16 with its top portion 50 opened toward the front of the casing 10 (i.e., in the direction of the transparent member 12) to enable access to the interior of the exterior casing 10. As will be described more fully further herein, lowering exterior casing 10 to metal plate 16 and providing access to the interior of exterior casing 10 by opening top portion 50 greatly facilitates maintenance of billboard apparatus 100.

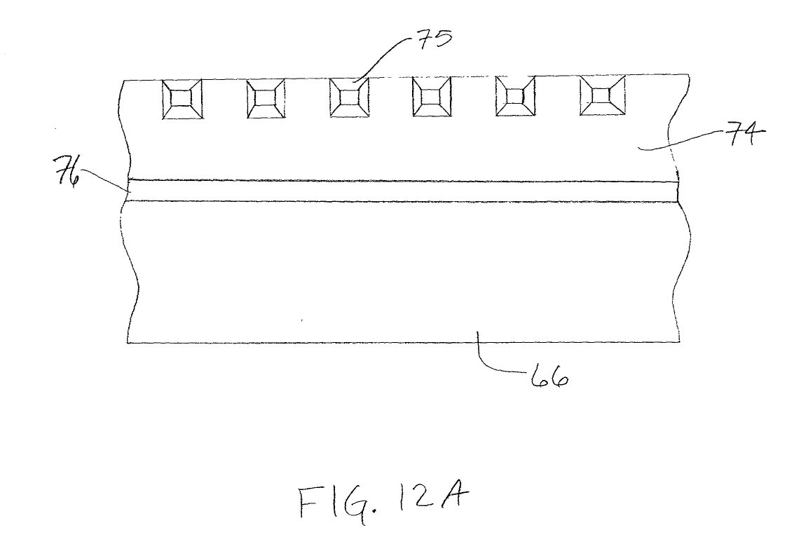

FIG. 11 shows a top plan view billboard apparatus 100 with top portion 50 opened in the manner shown in FIG. 10. FIG. 11 shows a fixed drum 60 and a movable drum 62 enclosed within exterior casing 10 at either end thereof. In accordance with the embodiments of the present invention, the drums 60 and 62 can assume any orientation, e.g., vertical, horizontal, or some angular position in between the two. In addition, billboard apparatus 100 may include more than one fixed drum 60 and more than one movable drum 62.

In a presently preferred embodiment of the present invention, drums 60 and 62 are made of aluminum and have grooved upper ends to hold and guide a belt attached to flexible member 66, as will be described further herein. In accordance with further embodiments of the present invention, sliding mechanism 64 is coupled to movable drum 62 to enable lateral movement of movable drum 62 for reasons that will be described further herein.

The exterior casing 10 further encloses a mechanism for continuously actuating drums 60 and 62 in a desired manner, e.g., a circular manner, a reciprocating manner, a “shaky” or jittery manner, or with interruptions in motion for a predetermined time period. In a presently preferred embodiment, the mechanism comprises a 0.25 kilowatt, 1400 rpm, electrical motor which is mechanically coupled to the drums 60 and 62 by a chain-bearing 1/50 attenuator, and can be located within interior frame 72 of FIGS. 5A-5C. It will be apparent to those skilled in the art that the capacity of the motor will vary in accordance with the particular application of the billboard 100. Furthermore, the motor may be coupled to drums 60 and 62 using any conventional mechanical coupling means that is known to those having ordinary skill in the art including, but not limited to, gears, sheaves, chains, cogwheels, and belts.

The operation of the motor can be controlled electronically, in a manner that is known to those having ordinary skill in the art, to actuate drums 60 and 62 as desired. For example, the operation of the motor can be controlled using a programmable inverter. The motor may also be controlled by, e.g., simple manual or electronic switches, or by using a simple electric or electronic brake. As will be appreciated by those having skill in the art, the motor may, in the alternative, be powered by gasoline, wind, or even by manual means.

A flexible member 66 can be transparent or semi-transparent, and is made from a flexible material, including but not limited to a membrane, a fabric, a thin metal sheet, a plastic film, or a vinyl material, upon which a desired background image can be printed or otherwise provided. In a presently preferred embodiment of the present invention, the flexible member 66 is fabricated as a single piece and its ends are attached to one another using appropriate machinery that is well known to those skilled in the art.

In a preferred embodiment of the present invention, flexible member 66 is inserted into the interior of the exterior casing 10 through the opening provided therein when top portion 50 is opened. The one-piece flexible member 66 slides around fixed drum 60 and movable drum 62, and sliding mechanism 64 can then be used to adjust the lateral position of movable drum 62 until flexible member 66 is taut around drums 60 and 62. Conversely, when the time comes to replace the flexible member 66, the sliding mechanism is adjusted to provide some slack in flexible member 66, thereby making flexible member 66 easier to remove through the top of exterior casing 10 when top portion 50 is opened.

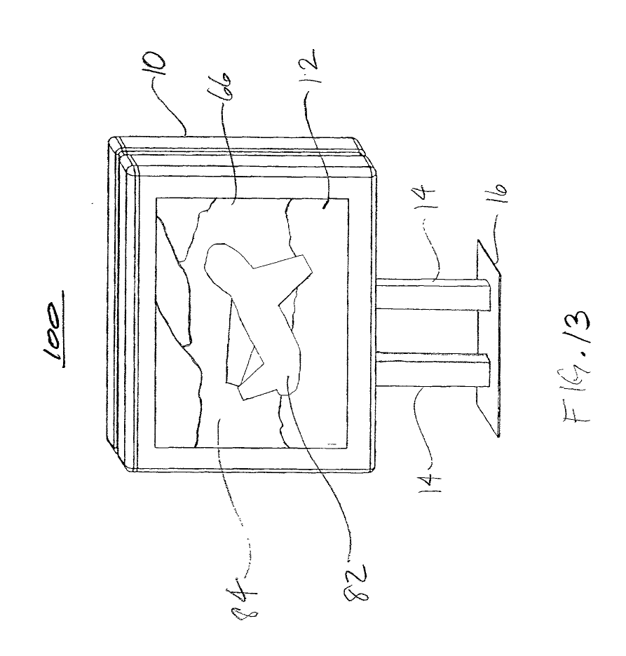

The flexible member 66 is secured within the exterior casing 10 using pairs of adjustable bearings 68 that are provided with structural members 70 of interior frame 72 located within the exterior casing 10. It will be appreciated by those skilled in the art that there can be any number of pairs of adjustable bearings 68 as necessary. Referring to FIGS. 12 and 12A, structural member 70 is provided with two pairs of bearings 68. In a presently preferred embodiment of the present invention, flexible member 66 is attached to a belt 74 using a fastener 76 . In the presently preferred embodiment, belt 74 is made from a durable elasticized plastic, and has trapezoidal protrusions 75 on one side along the whole length of its upper perimeter. Those skilled in the art will appreciate that belt 74 can have other shapes, and can be made from other, suitably durable materials. The fastener 76 is preferably a SCOTCHMATE Reclosable Fastener having model number SJ 3526 or SJ 3527 which is attached to flexible member 66 and belt 74 using an adhesive. Alternatively, the fastener 76 could be a zipper, one side of which could stitched to flexible member 66, and the other side of which could be stitched to belt 74. The stitching would preferably be performed using a high-frequency stitching machine.

After flexible member 66 has been lowered into the interior of exterior casing 10, belt 74 is positioned between the pairs of bearings 68 and the bearings 68 are adjusted to secure belt 74 between bearings 68 so that flexible member 66 is suspended from the several pairs of bearings 68. The pairs of bearings 68 are further adjustable in that the position of pairs of bearings 68 in relation to interior frame 72 can be adjusted to position flexible member 66 at a desired location between interior frame 72 and exterior casing 10.

Referring back to FIG. 11, as drums 60 and 62 are continuously actuated by the motor and the mechanical coupling means, the flexible member 66 is continuously in motion as rotation of fixed drum 60 and movable drum 62 causes belt 74 to move through the various pairs of bearings 78 which guide the motion of belt 74, and thus flexible member 66. Flexible member 66 thus comprises a movable medium within exterior casing 10.

The interior of exterior casing 10 includes a plurality of lighting elements 78 arranged to back-light the background image provided on flexible member 66. Lighting elements 78 may include, but are not limited to, projectors or fluorescent lights. In a presently preferred embodiment of the present invention, the lighting elements 78 are inserted into or removed from the interior of exterior casing 10 through the top of exterior casing 10 after top portion 50 is opened. Lighting elements 78 are provided on drawers 80 that are slid into and out of the interior of exterior casing 10. The maintenance of billboard 100 is thus greatly facilitated because, for example, lighting elements 78 can be accessed and replaced quickly, easily, and without the need to remove flexible member 66.

Referring to FIG. 13, according to an embodiment of the present invention an object 82 is provided in front of background image 84 on the flexible member 66. The object 82 can be a three-dimensional object or a two-dimensional image that is printed on any of various materials that can have an image printed on them and that have a thickness and strength that are suitable for the particular application. Such materials are known to those skilled in the art, and include but are not limited to vinyl, metal, hardboard, or plastic.

In one embodiment according to the present invention, the object 82 is a two-dimensional image that is attached to the transparent member 12 by any suitable means that is resistant to environmental factors such as water, ultraviolet radiation, and temperature. Such means are known to those skilled in the art, and include but are not limited to glue, adhesives, and the like. In a preferred embodiment, the object 82 is a sticker (i.e., an adhesive material) which is removably attached to the transparent member 12 in such a way that the object 82 can be easily replaced by another object, thereby rendering the billboard 100 quickly and easily adaptable to advertise a wide variety of products and services. Additionally, the object 82 has an opaque coating on its rear side to block light emanating from lighting elements 78.

In an alternative embodiment according to the present invention, the object 82 is attached to the exterior casing 10, which permits the object 82 either to maintain a fixed position in relation to the exterior casing 10 or to move in any direction in relation to the exterior casing 10. The object 82 may, for example, be attached to the frame by glue, adhesives, or by any suitable mechanical attachment means that are known to those skilled in the art, e.g., bolts. The object 82 may also be attached to the exterior casing 10 by a wire, a spring, or some other flexible means known to those skilled in the art that permits movement of the object 82. Again, in a preferred embodiment, the object 82 is removably attached to the exterior casing 10 in such a way that the object 82 can be easily replaced by another object, thereby rendering the billboard 100 quickly and easily adaptable to advertise a wide variety of products and services. The movement of the object 82 may be partial (i.e., a portion of the object 82 can move) or total, and it may include, but is not limited to, palindromic, up-down, or pendulous movement. In each of the embodiments according to the present invention, the movement of the background image 84 in relation with the object 82 in front of it creates the effect that the object 82 is moving in relation to the background image 84.

In alternative embodiments of the present invention, suitable external lighting elements, including but not limited to projectors or fluorescent lights, can be placed on the exterior casing 10 to illuminate object 82 and background image 84 in the absence of sunlight.

The exterior casing 10 can also be equipped at various positions thereon to produce a variety of effects to stimulate the senses of the spectator or passerby, thereby supplementing the effect of the object 82 moving in relation to the background image 84 behind it. Such effects can include, but are not limited to, the emission of perfume or smoke and the reproduction of music. The nature of the particular effects, and the manner of equipping the exterior casing 10 to provide these effects, is known in the art and will not be described further herein.

In the exemplary embodiment shown in FIG. 13, the exterior casing 10 is manufactured from a metal sheet having a thickness of 4 mm. The transparent member 12 in the opening of the exterior casing 10 is made of glass. Object 82 and background image 84 in this embodiment comprise, respectively, an airplane and a blue sky with clouds. The object 82 of the airplane may be printed on vinyl, and the flexible member 66 upon which the background image 84 of the blue sky is printed may also be vinyl.

The embodiments of the present invention that have been described herein have several advantages. Using the pairs of adjustable bearings 68 to secure belt 74 of flexible member 66 renders flexible member 66 less likely to tear as quickly as with other, prior art attachment schemes. The pairs of bearings 68 also facilitate replacement and adjustment of flexible member 66, despite variations in the weight of flexible member 66 resulting from differences in the printing of background image 84 thereon. Opening top portion 50 of exterior casing 10 enables faster, easier, and less costly placement and replacement of flexible member 66 in the interior of exterior casing 10. Lighting elements 78 can also be more easily replaced, even when flexible member 66 remains attached to the pairs of bearings 68. Replacement of flexible member 66 is made faster and less costly in terms of labor and equipment, because there are less places necessary to connect the interior vinyl theme.

Replacement of flexible member 66 and object 82 is also faster, safer, and easier. Billboard 100 can be lowered using footing beams 14 and suspension frame 20 when any maintenance is necessary, including but not limited to replacement of flexible member 66, object 82, and lighting elements 78. It is also easier for a worker to accurately place object 82 when exterior casing 10 is lowered to ground level.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims. For example, the object 82 and the background image 84 are not limited to an airplane against a background of blue sky and clouds. Other examples may include: a boat or ship against a background of a body of water, such as an ocean, a sea, a lake, or a river; or a balloon against a background having skyscrapers and a blue sky, wherein a package of brand-name cigarettes is interposed between two of the skyscrapers. As will be appreciated by those skilled in the art after reading the foregoing description, an endless variety of objects 82 can be used in conjunction with an endless variety of background images 84 to promote an endless variety of products and services without departing from the scope or spirit of the invention as defined in the appended claims.

What is claimed is:

1. An apparatus for displaying advertising, said apparatus comprising:
an exterior casing;
a movable medium which moves within said exterior casing and which displays an image thereon;
an object disposed in front of said movable, whereby the movement of said image in relation with said object creates the effect that said object is moving in relation to said image; and
a base structure that enables vertical movement of said exterior casing to facilitate access to said apparatus.

2. The apparatus of claim 1, further comprising a suspension frame coupled to said base structure to effect said vertical movement of said exterior casing.

3. The apparatus of claim 2, wherein said suspension frame is secured to said exterior casing.

4. The apparatus of claim 2, further comprising an interior frame, wherein said suspension frame is secured to said interior frame.

5. The apparatus of claim 2, wherein said base structure comprises at least one vertical beam.

6. The apparatus of claim 5, wherein said suspension frame moves vertically along said at least one vertical beam.

7. The apparatus of claim 6, further comprising at least one cable having a first end coupled to said suspension frame.

8. The apparatus of claim 7, further comprising at least one winch coupled to a second end of said cable, said winch actuated to lower or raise said suspension frame.

9. The apparatus of claim 1, wherein said exterior casing comprises a top portion that can be opened to provide access to the interior of said exterior casing.

10. An apparatus for displaying advertising, said apparatus comprising:
an exterior casing;
a frame located within the interior of said external casing, said frame provided with a plurality of pairs of bearings;
a movable medium which moves within said exterior casing and which displays an image thereon;
said movable medium comprising a belt at a top perimeter thereof, said belt secured between said bearings; and
an object disposed in front of said movable medium, whereby the movement of said image in relation with said object creates the effect that said object is moving in relation to said image.

11. The apparatus of claim 10, wherein each of said pairs of bearings is adjustable to secure said belt between said bearings.

12. The apparatus of claim 11, wherein each of said pairs of bearings is adjustable to position said flexible member at a desired location between said interior frame and said exterior casing.

13. A method for displaying advertising, said method comprising the steps of:
moving a medium which displays an image thereon within an exterior casing;
disposing an object in front of said medium, whereby the movement of said image in relation with said object creates the effect that said object is moving in relation to said image; and
enabling vertical movement of said exterior casing along a base structure to facilitate access to said apparatus.

14. The method of claim 13, wherein said enabling step comprises the step of coupling a suspension frame to said base structure.

15. The method of claim 14, wherein said coupling step comprises the step of securing said suspension frame to said exterior casing.

16. The method of claim 14, further comprising the steps of:
providing an interior frame within said exterior casing; and
securing said suspension frame to said interior frame.

17. The method of claim 14, wherein said enabling step comprises providing at least one vertical beam for said base structure.

18. The method of claim 17, further comprising the step of moving said suspension frame vertically along said at least one vertical beam.

19. The method of claim 18, further comprising the step of coupling at least one cable to said suspension frame.

20. The method of claim 19, further comprising the steps of:
coupling each of said at least one cable to a corresponding winch such that the number of winches equals the number of cables; and
actuating said winches to lower or raise said suspension frame.

21. The method of claim 13, further comprising the step of opening a top portion of said exterior casing to provide access to the interior of said exterior casing.

22. A method for displaying advertising, said method comprising the steps of:
providing an exterior casing;
locating a frame located within the interior of said external casing;
providing said frame with a plurality of pairs of bearings;
moving a medium which displays an image thereon within said exterior casing; and
securing a top perimeter of said movable medium between said bearings; and
disposing an object in front of said movable medium, whereby the movement of said image in relation with said object creates the effect that said object is moving in relation to said image.

23. The method of claim 22, further comprising the step of adjusting each of said pairs of bearings to secure said movable medium between said bearings.

24. The method of claim 23, further comprising the step of adjusting each of said pairs of bearings to position said flexible member at a desired location between said interior frame and said exterior casing.
